(19) United States
(12) Patent Application Publication
(10) Pub. No.: US 2010/0138466 A1
(43) Pub. Date: Jun. 3, 2010

(54) Filter coefficient calculation method and filter coefficient calculation unit

(75) Inventors: Ryoji Yanase, Kanagawa (JP); Takeshi Takanashi, Kanagawa (JP); Koichiro Suzuki, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/591,642

(22) Filed: Nov. 25, 2009

(30) Foreign Application Priority Data
Nov. 28, 2008 (JP) 2008-304162

(51) Int. Cl. G06F 17/10

(52) U.S. Cl. 708/300

(57) ABSTRACT

Provided is a filter coefficient calculation method that calculates filter functions, each having (2n+1) rows and (2n+1) columns (n is an integer), the method including calculating a first filter function in accordance with a set value that is externally input, calculating an error between a total sum of values included in the first filter function and an ideal value of the total sum, supplying an odd error included in the error to a first origin coefficient that is located at a center of the first filter function as a first correction value if the error is an odd number, and supplying an even error to one of the first origin coefficient and a coefficient pair that is located symmetrically with respect to a point of the first origin coefficient as a second correction value, the even error being the error except the odd error.

### BACKGROUND

1. Field of the Invention

The present invention relates to a filter coefficient calculation method and a filter coefficient calculation unit, and more specifically, to a filter coefficient calculation method and a filter coefficient calculation unit that correct coefficients of filter functions represented by determinants having odd rows and odd columns.

2. Description of Related Art

In recent years, display units such as televisions have been made larger in size and highly defined. However, it is often the case that a source image displayed on a display unit has a lower resolution than the display unit. In such a case, the source image is enlarged for display, which causes blur in the image which is enlarged. When the image is processed to be enlarged, filter processing is often performed on the enlarged image with a Gaussian filter or a Laplacian filter in order to sharpen the image and to prevent the blur of the image.

Further, the Gaussian filter and the Laplacian filter also perform processing of normalizing values when performing calculation processing of filter functions. As division operation is employed in this normalization, rounding error may occur in coefficients, which may produce an error between filter functions after being normalized and an ideal value. As such, the normalization error that is caused when normalizing the filter coefficients needs to be corrected.

A method of cancelling the normalization error of the filter coefficients occurred by normalization is disclosed in Japanese Unexamined Patent Application Publication No. 2004-253944. FIG. 6 shows a filter circuit 100 disclosed in Japanese Unexamined Patent Application Publication No. 2004-253944. As shown in FIG. 6, the filter circuit 100 includes a weight coefficient calculation unit 101, a weight normalizing means 102, a maximum weighting coefficient calculating means 103, a normalization error correcting means 104, and an interested pixel value generating unit 105.

The weight coefficient calculation unit 101 obtains weighting coefficients of neighboring pixels from the information of the neighboring pixels and an interested pixel. The weight normalizing means 102 normalizes the weighting coefficients of the neighboring pixels calculated by the weight coefficient calculation unit 101. The maximum weighting coefficient calculating means 103 selects a maximum weighting coefficient among the weighting coefficients of the neighboring pixels calculated by the weight coefficient calculation unit 101. The normalization error correcting means 104 corrects the normalization error occurred in the weight normalizing means. The interested pixel value generating unit 105 calculates interpolating data at the interested pixel position from error-corrected normalized weighting coefficients by the normalization error correcting means 104 and the pixel values of the neighboring pixels.

In this filter circuit 100, the maximum weighting coefficient selected by the maximum weighting coefficient calculating means 103 is corrected to correct the normalization error. In other words, according to the filter circuit 100, even when the value of the coefficient is changed, the influence of the error correction can be reduced by setting the changed value as the maximum weighting coefficient.

### SUMMARY

However, in the Gaussian filter and the Laplacian filter, the values of the weighting coefficients become larger as their distance to the center of the determinant that forms filters decreases. Accordingly, in the filter circuit 100, the weighting coefficients that are changed due to the correction of the normalization error are substantially at the same location in any filter. Thus, in the filter circuit 100, there is no high degree of freedom in the correction method of the normalization error and the flexible correction in accordance with the filter characteristics cannot be realized.

A first exemplary aspect of an embodiment of the present invention is a filter coefficient calculation method that calculates filter functions, each having (2n+1) rows and (2n+1) columns (n is an integer), the method including calculating a first filter function in accordance with a set value that is externally input, calculating an error between a total sum of values included in the first filter function and an ideal value of the total sum, supplying an odd error included in the error to a first origin coefficient that is located at a center of the first filter function as a first correction value if the error is an odd number, and supplying an even error to one of the first origin coefficient and a coefficient pair that is located symmetrically with respect to a point of the first origin coefficient as a second correction value, the even error being the error except the odd error.

A second exemplary aspect of the present invention is a filter coefficient calculation unit including a weight coefficient calculation unit that calculates a first filter function having (2n+1) rows and (2n+1) columns (n is an integer) according to a set value that is externally input, an error calculation unit that calculates an error between a total sum of values included in the first filter function and an ideal value of the total sum, an odd error correction unit that supplies an odd error included in the error to a first origin coefficient that is located at a center of the first filter function as a first correction value if the error is an odd number, so as to correct the first origin coefficient, and an even error correction unit that supplies an even error to one of the first origin coefficient and a coefficient pair that is located symmetrically with respect to a point of the first origin coefficient as a second correction value, the even error being the error except the odd error, so as to correct the error of the first filter function.

According to the filter coefficient calculation method and the filter coefficient calculation unit of the present invention, when the error between the filter functions and the ideal value is an odd number, the odd error included in the error is supplied to the origin coefficient as a first correction value. The even error except for the odd error can be divided to any one of the origin coefficient and the neighboring coefficients. On the other hand, when the error is an even number, the error can be divided to any one of the origin coefficient and the neighboring coefficients. Hence, according to the filter coefficient calculation method and the filter coefficient calculation unit of the present invention, it is possible to improve the degree of freedom of the correction method of the filter coefficients included in the filter functions.

According to the filter coefficient calculation method and the filter coefficient calculation unit of the present invention, it is possible to provide an error correction method with high degree of freedom regarding the correction method of the filter functions.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a schematic diagram of a first filter function according to a first exemplary embodiment;

FIG. 2 is a schematic diagram of a second filter function according to the first exemplary embodiment;

FIG. 3 is a block diagram of a filter coefficient calculation unit according to the first exemplary embodiment;

FIG. 4 is a flow chart showing a process flow of the filter coefficient calculation unit according to the first exemplary embodiment;

FIG. 5 is a block diagram of an image processing device according to a second exemplary embodiment; and

FIG. 6 is a block diagram of a filter circuit disclosed in Japanese Unexamined Patent Application Publication No. 2004-253944.

### DETAILED DESCRIPTION OF THE EXEMPLARY EMBODIMENTS

### First Exemplary Embodiment

The exemplary embodiments of the present invention will be described with reference to the drawings. Description will be made first of filter functions that are generated by a filter coefficient calculation unit 10 according to the first exemplary embodiment. The filter coefficient calculation unit 10 according to the first exemplary embodiment generates filter functions that correspond to one of a Gaussian filter and a Laplacian filter. In the following description, each method of calculating the filter functions according to the Gaussian filter and the Laplacian filter will be described.

In the filter coefficient calculation unit 10 according to the first exemplary embodiment, a plurality of filter functions that include the same origin coefficient and different neighboring coefficients are generated based on one set value σ. Note that the set value σ is a standard deviation that will be described later. Typically, filter processing in image processing follows normal distribution of Gaussian distribution. An optimal value is determined as the set value σ in accordance with measurement accuracy and characteristics of cameras or lenses from this normal distribution property. In the first exemplary embodiment, this σ is obtained with proper means, and is supplied to the filter coefficient calculation unit 10. Each of the filter functions treated in the first exemplary embodiment is expressed by a determinant with (2n+1) rows and (2n+1) columns (n is an integer). In summary, each of the filter functions treated in the first exemplary embodiment has a form of determinant with odd rows and odd columns, and includes (2n+1)×(2n+1) coefficients. In this specification, these coefficients are referred to as filter coefficients (or simply coefficients). Further, the coefficient located at a center of the filter coefficients included in the determinant is hereinafter called origin coefficient, and the other coefficients are called neighboring coefficients. These filter functions correspond, for example, to luminance or color change directions of the input image data.

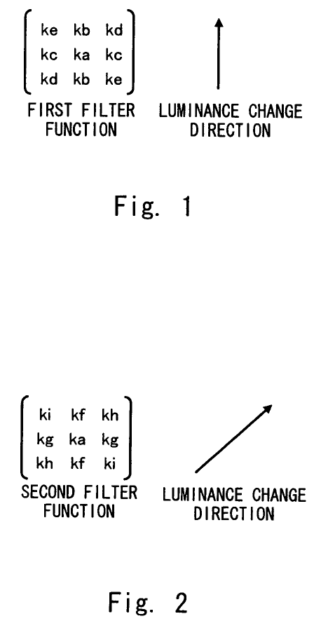

Now, one example of the filter functions is shown in FIGS. 1 and 2. The filter function shown in FIG. 1 is a first filter function that corresponds to input image data where luminance varies from the lower side to the upper side in the drawing. The filter function shown in FIG. 2 is a second filter function that corresponds to input image data where luminance varies from the lower left side to the upper right side in the drawing. The filter functions are typically provided for each luminance change direction of the image data, or for each color change direction. In the first exemplary embodiment, the filter functions correspond to the luminance change directions of the input image data, as an example. Further, as shown in FIGS. 1 and 2, both origin coefficients of the first filter function and the second filter function are ka. On the other hand, the neighboring coefficients of the first filter function (kb to ke in the drawing) and the neighboring coefficients of the second filter function (kf to ki in the drawing) are different from each other. Further, as shown in FIGS. 1 and 2, in the first filter function and the second filter function, the neighboring coefficients that are located in symmetrical with respect to a point of the origin coefficient have the same value. The reason why the origin coefficients of the plurality of filters have the same value and why the neighboring coefficients that are located in symmetrical with respect to a point have the same value will be described later.

Next, the calculation method of the Gaussian filter will be described. The Gaussian filter is one of averaging filters, and is a weighted averaging filter so that the original pixel's value receives the heaviest weight and neighboring pixels receive smaller weights as their distance to the original pixel increases. At this time, according to the Gaussian filter, the weighting coefficients are set based on Gaussian distribution. Further, the total value of the coefficients becomes 1 in the Gaussian filter. In summary, when the coefficient included in the filter function of x row and y column is represented by k(x, y), the following equation (1) is satisfied.

Σk(x, y)=1 (1)

Further, each coefficient of the Gaussian filter can be expressed by equation (2). Note that equation (2) is satisfied in case of two-dimensional Gaussian distribution, and σ² represents distribution. Note that σ represents standard deviation.

k(x, y)=(exp(−(x²+y²)/2σ²))/2πσ² (2)

In the Gaussian filter, the sum of each coefficient calculated from equation (2) is calculated, and each coefficient is divided by the sum to normalize the coefficient. Further, as the origin coefficient is x=0, y=0, it is understood from equation (2) that, when generating the plurality of filters based on the same set value σ, the values are identical to each other. It is also understood from equation (2) that, as the coefficients that are located symmetrical with respect to a point have the same value as a result of calculation of (x²+y²), the coefficients that are located symmetrical with respect to a point have the same value.

Next, the calculation method of the Laplacian filter will be described. The Laplacian filter is also one of the weighted averaging filters. In this case, in the Laplacian filter, the weighting coefficients are set based on two-dimensional Gaussian distribution. Further, the total value of the coefficients is 0 in the Laplacian filter. In short, the following equation (3) is satisfied when representing the coefficient that is included in the filter function of x row and y column by k(x, y).

Σk(x, y)=0 (3)

Further, each of the coefficients of the Laplacian filter is indicated by a calculation expression of Laplacian based on the two-dimensional Gaussian distribution. This calculation expression of Laplacian is shown in equation (4). σ² in equation (4) represents distribution. Note that σ represents standard deviation.

k(x, y)=(exp(−(x²+y²)/2σ²))*((x²+y²−2σ²)/2πσ⁶) (4)

In the Laplacian filter, the average value of each coefficient calculated by equation (4) is calculated, and the average value that is calculated is subtracted from each coefficient to normalize the coefficient. Further, as the origin coefficient is x=0, y=0, it is understood from equation (4) that, when the plurality of filters are generated based on the same set value σ, the values are identical to each other. Further, it is understood from equation (4) that, as the coefficients that are located symmetrical with respect to a point have the same value as a result of calculation of (x²+y²), the coefficients that are located symmetrical with respect to a point have the same value.

The filter coefficient calculation unit 10 according to the first exemplary embodiment performs calculation of the filter functions and correction of the normalization error that is generated in the calculation of the filter functions. Description will now be made detail of the filter coefficient calculation unit 10 according to the first exemplary embodiment and the correction method of the normalization error in the filter coefficient calculation unit 10.

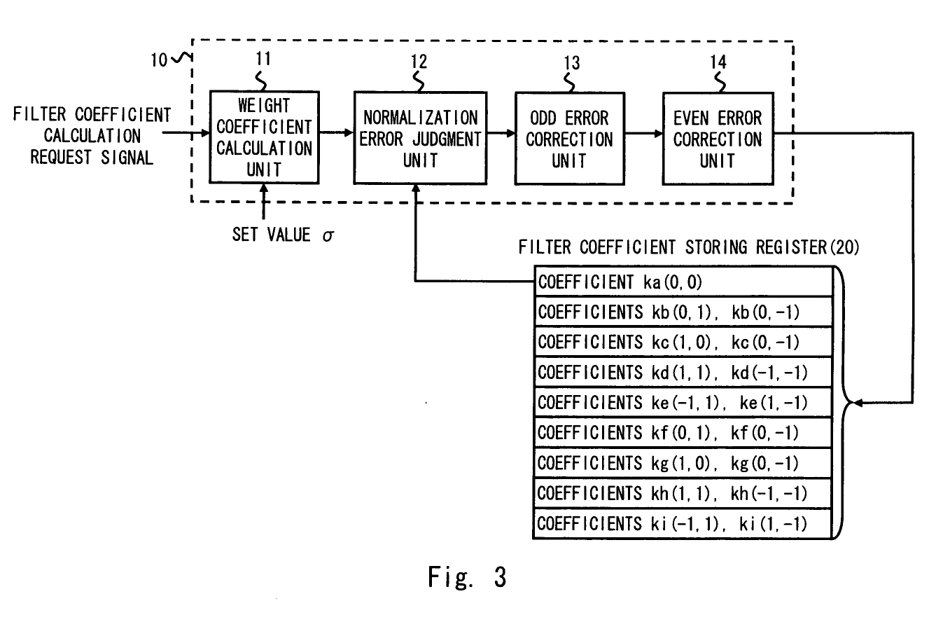

FIG. 3 shows a block diagram of the filter coefficient calculation unit 10 according to the first exemplary embodiment. In FIG. 3, a filter coefficient storing register 20 is shown in addition to the filter coefficient calculation unit 10. In the first exemplary embodiment, the filter coefficients included in the filter functions generated by the filter coefficient calculation unit 10 are stored in the filter coefficient storing register 20 that is separately arranged from the filter coefficient calculation unit 10. FIG. 3 shows the filter coefficient storing register 20 in which the two filter functions are stored as an example. This filter coefficient storing register 20 may be formed on a semiconductor substrate that is different from the filter coefficient calculation unit 10, or may be formed on the same semiconductor substrate. As shown in FIG. 3, the filter coefficient calculation unit 10 includes a weight coefficient calculation unit 11, a normalization error judgment unit 12, an odd error correction unit 13, and an even error correction unit 14.

Upon externally receiving a filter coefficient calculation request signal, the weight coefficient calculation unit 11 generates the first filter function in accordance with the set value σ. This first filter function is a determinant having odd rows and odd columns, and includes odd numbers of filter coefficients. Further, the first filter function is the Gaussian filter or the Laplacian filter that is discussed above. The set value σ is equal to a that is used in equation (2) or equation (4), which is externally input. In the first exemplary embodiment, the same set value σ is used in generating the plurality of filter functions that correspond to the luminance change directions.

The normalization error judgment unit 12 calculates the normalization error of the first filter function that is generated in the weight coefficient calculation unit 11 to judge whether the normalization error is the odd number or even number. This normalization error corresponds to the error between the condition shown in equation (1) and the total number of filter coefficients of the first filter function when the first filter function is the Gaussian filter. On the other hand, when the first filter function is the Laplacian filter, the normalization error corresponds to the error between the condition shown in equation (3) and the total number of filter coefficients of the first filter function. Further, the normalization error judgment unit 12 generates a third filter function by replacing the origin coefficient of the filter function that is generated secondly or later (hereinafter the filter function that is generated secondly or later is referred to as second filter function) with the origin coefficient of the first filter function in calculating the normalization error of the plurality of filter functions that correspond to luminance change directions. Then, the normalization error judgment unit 12 judges whether the normalization error of the third filter function is the odd number or the even number.

In the first exemplary embodiment, the filter coefficients are treated as values of binary numbers. In such a case, the normalization error judgment unit 12 refers to the lower one bit of the value calculated as the normalization error, so as to be able to judge whether the normalization error is the odd number or the even number. For example, the normalization error is judged as the odd number when the lower one bit of the normalization error is 1, and the normalization error is judged as the even number when the lower one bit is 0.

As the two neighboring coefficients that are located symmetrical with respect to a point of origin coefficient have the same value in the filter function according to the first exemplary embodiment, the normalization error generated in the neighboring coefficients is an even number. Further, when the normalization error of the filter function is an odd number, the odd number component results from the origin coefficient, and the origin coefficients of the plurality of filter functions are equal to each other. Hence, in the first exemplary embodiment, when the normalization error of the first filter function is the odd number, the normalization error of the filter function that is generated secondly or later (second filter function) is also the odd number. Further, when the normalization error of the first filter function is the even number, the normalization error of the filter function that is generated secondly or later (second filter function) is also the even number. Note that, when the origin coefficient of the second filter function is replaced in the normalization error judgment unit 12, the normalization error of the second filter coefficient is the even number. This is because, when the normalization error is the odd number, the origin coefficient is corrected to the even number by the odd error correction unit 13 described below.

The odd error correction unit 13 corrects the odd error included in the normalization error upon judgment by the normalization error judgment unit 12 that the normalization error is the odd number. In this case, the odd error correction unit 13 supplies the odd error to the origin coefficient as a first correction value. The magnitude of the odd error may be the same value as the normalization error or may be the odd value that is smaller than the normalization error. In the first exemplary embodiment, the filter coefficient is represented by a binary number. Accordingly, the origin coefficient can be the even value if the first correction value that makes σ value of lower one bit of the origin coefficient zero is supplied. In summary, according to the first exemplary embodiment, the magnitude of the first correction value is not specifically limited as long as the value of the lower one bit of the origin coefficient becomes 0. When the normalization error is the even number, the odd error correction unit 13 outputs the first filter function to the even error correction unit 14 that is connected to the odd error correction unit 13 without performing any correction. In the first exemplary embodiment, in the second filter coefficient that is generated secondly or later, the normalization error is an even number due to the replacement of the origin coefficient. Thus, the odd error correction unit 13 does not perform substantial operation in the filter function generation processing that is performed secondly or later.

The even error correction unit 14 performs correction of the even error on the first filter coefficient output from the odd error correction unit 13. This even error is a second correction value. When the normalization error is the odd number, this even error is the value that is obtained by removing the odd error from the normalization error. When the normalization error is the even number, this even error is the same value as the normalization error. The even error correction unit 14 supplies the second correction value to one of the origin coefficient and the two neighboring coefficients that are symmetrical with respect to a point of origin function. More specifically, when the second correction value is supplied to the two neighboring coefficients, the even error correction unit 14 divides the second correction value equally, and supplies the equally divided second correction value to each of the two neighboring coefficients.

The filter coefficient included in the first filter function that is corrected in the even error correction unit 14 is stored in the filter coefficient storing register 20. In this case, according to the first exemplary embodiment, the origin coefficient ka(0,0) of the first filter function is stored in a predetermined address. Further, as the neighboring coefficients of the first filter function that are symmetrical with respect to a point of origin coefficient have the same value, the value of the two neighboring coefficients is stored in one register. In the example shown in FIG. 3, the value that corresponds to the two neighboring coefficients of the coefficient kb(0, 1) and the coefficient kb(0, −1) that is symmetrical to the coefficient kb(0, 1) is stored in one register. Further, regarding the filter coefficients of the second filter function, only the neighboring coefficients are stored in the filter coefficient storing register 20. As the origin coefficient (ka(0,0)) of the second filter function is equal to the origin coefficient (ka(0,0)) of the first filter function, it has already been stored in the filter coefficient storing register 20. In the example shown in FIG. 3, the first filter function is formed of the coefficient ka and the coefficients kb to ke, and the second filter function is formed of the coefficient ka and the coefficients kf to ki. Note that the origin coefficient of the first filter function stored in the filter coefficient storing register 20 is referred to by the normalization error judgment unit 12.

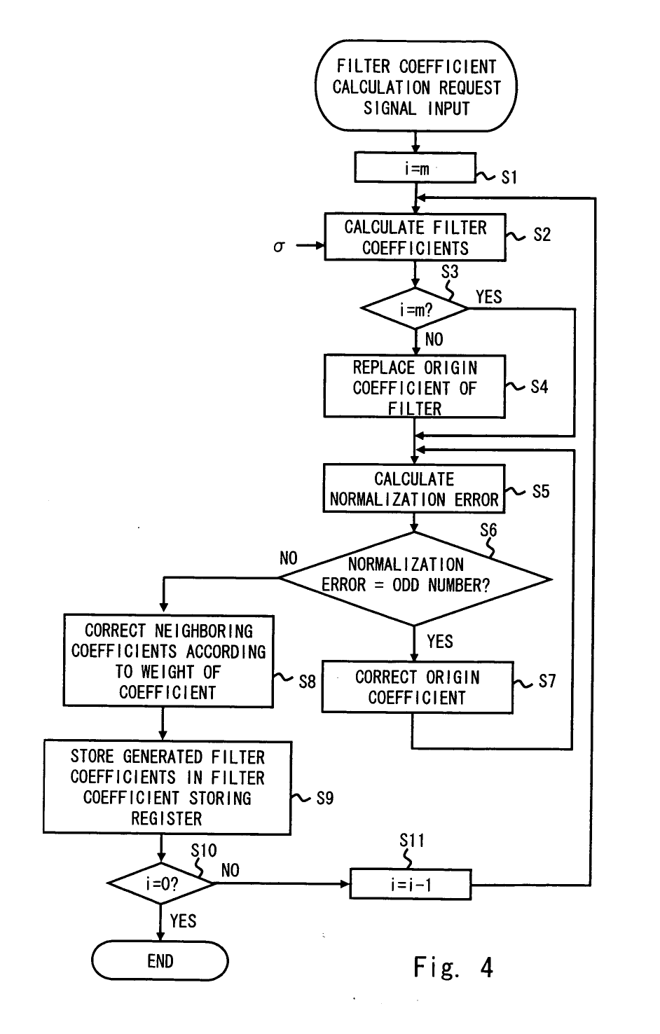

Now, the flow of the count correction and the calculation of the filter coefficients of the filter coefficient calculation unit 10 according to the first exemplary embodiment will be described. FIG. 4 shows a flow chart of the count correction and the calculation of the filter coefficients of the filter coefficient calculation unit 10.

As shown in FIG. 4, upon receiving the filter coefficient calculation request signal, the filter coefficient calculation unit 10 starts the generation of the filter functions. In order to generate the filter functions, a variable number i is initialized by a value m (step S1). The value m indicates the number of filter functions that are to be generated, and is an integer of one or more. The value m may be supplied by a signal such as a filter coefficient calculation request signal or the like, or may be set in advance.

Subsequently, the weight coefficient calculation unit 11 calculates the filter coefficients included in the first filter function (step S2). It is then judged whether the variable number i is equal to the value m in the normalization error judgment unit 12 (step S3). When the variable number i is equal to the value m, it is judged that the filter function output from the weight coefficient calculation unit 11 is the first filter function. Thus, the process goes to step S5 without executing step S4.

In step S5, the normalization error judgment unit 12 calculates the normalization error of the first filter function. Then, the normalization error judgment unit 12 judges whether the normalization error which is calculated is the odd number or even number (step S6). When the normalization error is judged as the odd number by the judgment of step S6 (Yes in step S6), the odd error correction unit 13 supplies the first correction value that has an odd number value to the origin coefficient (step S7). The processing is then made back to step S5. The normalization error judgment unit 12 then calculates the normalization error again. It is then judged whether the normalization error of the filter function after the correction is the odd number or not. As the normalization error is the even number by the correction in step S6, the process goes to step S8 (No in step S6). Note that, when the normalization error is judged as the even number in the first processing of step S6, the process goes to step S8 without executing step S7.

In step S8 in the first exemplary embodiment, the second correction value is divided between each of the neighboring coefficients according to the weight of each coefficient. Note that, in the correction processing of step S8, the second correction value may be supplied only to the origin coefficient, or may be supplied only to a pair of neighboring coefficients that are symmetrical with respect to a point.

Then, the filter coefficients of the filter function that are corrected in step S8 are stored in the filter coefficient storing register (step S9). Subsequently, it is judged in the weight coefficient calculation unit whether the variable number i is 0 (step S10). When the variable number i is not 0 in step S10 (No in step S10), the value of the variable number i is reduced by one (step S11). Then, the second filter function is generated after going back to step S2 again.

In generating the filter function that is generated secondly or later, it is judged as No in step S3 and the process goes to step S4. In step S4, the origin coefficient of the second filter function is replaced with the origin coefficient of the first filter function. By performing this replacement processing, the origin coefficient of the second filter function becomes equal to that of the first origin coefficient, and at the same time, the normalization error of the second filter function is the even number. Thus, in the filter function generation processing that is performed secondly or later, it is judged in step S6 as No. The filter coefficient calculation unit 10 then repeats the processing of steps S2 to S11 until when the variable number i becomes 0, and upon judgment that the variable number i becomes 0 in step S10, the processing is completed.

From the above description, according to the filter coefficient calculation method and the filter coefficient calculation unit 10 in the first exemplary embodiment, the odd error included in the normalization error is corrected by the origin coefficient and the remaining even error may be corrected by any one of the origin coefficient and the neighboring coefficients when the normalization error is the odd number. In summary, according to the filter coefficient calculation method and the filter coefficient calculation unit 10 in the first exemplary embodiment, the correction method of the normalization error can be freely selected by user's intention. The example described above (FIG. 3) shows a case in which two filter functions are used. However, the present invention may be applied to a case in which three or more filter functions are used as shown in the flow chart in FIG. 4 or only one filter function is used.

According to the filter coefficient calculation method and the filter coefficient calculation unit 10 in the first exemplary embodiment, the even error can be divided between a plurality of neighboring coefficients. For example, by dividing the normalization error between the neighboring coefficients in accordance with the weight of the neighboring coefficients, the normalization error can be corrected without deteriorating the ratio of the neighboring coefficients. By performing such a correction, the accuracy of the filter functions can be improved.

Further, the filter coefficient calculation method and the filter coefficient calculation unit 10 according to the first exemplary embodiment are specifically effective in reducing the digit number of the filter coefficients included in the filter functions. When the digit number of the filter coefficients is reduced, rounding error occurs in the filter coefficients, which causes error between the condition of equations (1) and (3) and the filter coefficients. However, the filter coefficient calculation method and the filter coefficient calculation unit 10 according to the first exemplary embodiment are able to calculate the rounding error as the normalization error to correct it by the odd error correction unit 13 and the even error correction unit 14.

Further, the filter coefficient calculation method and the filter coefficient calculation unit 10 according to the first exemplary embodiment are able to suppress the capacity of the filter coefficient storing register that stores the filter coefficients when the plurality of filter functions are used. In the filter coefficient calculation method and the filter coefficient calculation unit 10 according to the first exemplary embodiment, the origin coefficient is common among the plurality of filter coefficients. In summary, the filter coefficient storing register only needs to have one register to store the origin coefficient. Accordingly, even when the number of filter functions that are generated is increased, the number of registers to store the origin coefficient is not increased in the filter coefficient calculation method and the filter coefficient calculation unit 10 according to the first exemplary embodiment.

### Second Exemplary Embodiment

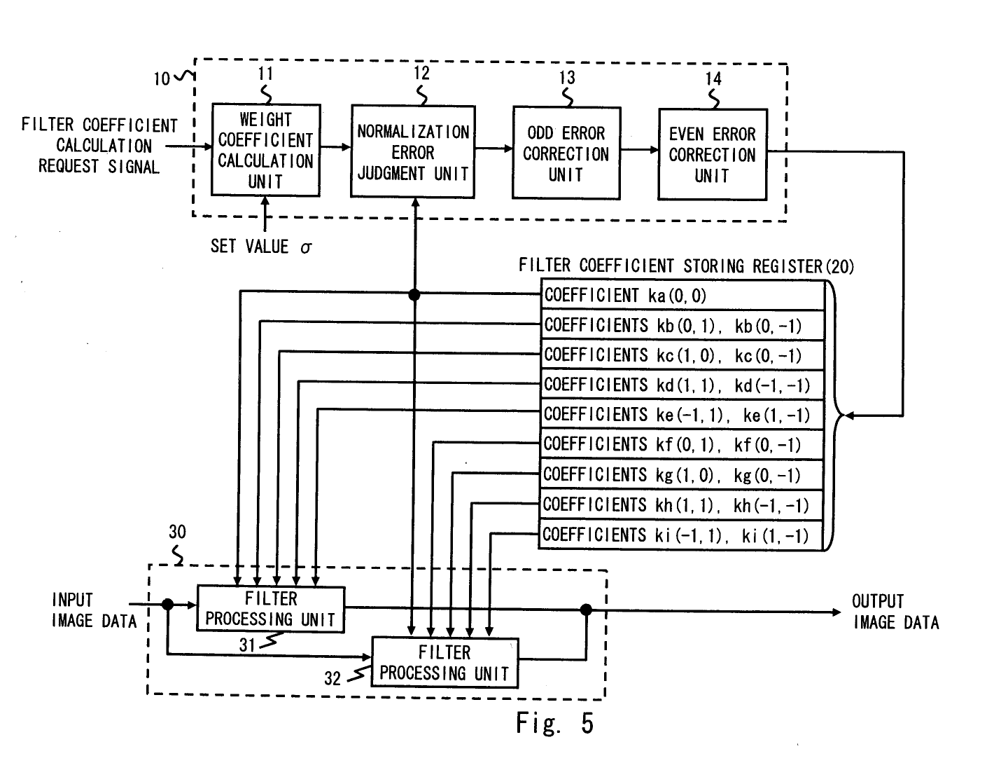

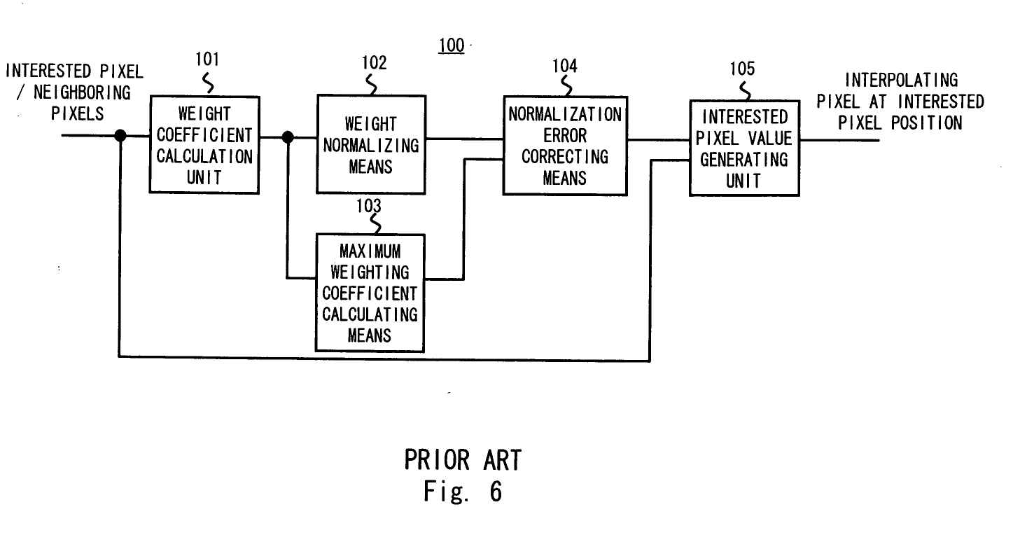

While the filter coefficient calculation unit 10 and the filter coefficient calculation method have been described in the first exemplary embodiment, an image processing device that uses the filter functions calculated by the filter coefficient calculation unit 10 will be described in the second exemplary embodiment. FIG. 5 shows an image processing device according to the second exemplary embodiment. This image processing device includes a filter coefficient calculation unit 10, a filter coefficient storing register 20, and an image processing circuit 30. Note that the filter coefficient calculation unit 10 and the filter coefficient storing register 20 are the same to those described in the first exemplary embodiment, and thus description will be omitted. Further, the filter coefficient calculation unit 10, the filter coefficient storing register 20, and the image processing circuit 30 may be formed on the same semiconductor substrate or may be formed on the separate semiconductor substrates. Further, the image processing device according to the second exemplary embodiment shown in FIG. 5 shows a case in which two filter functions are used. Note that the present invention may be applied to a case in which two or more filter functions are used in accordance with the specs of the image processing device as well.

The image processing circuit 30 includes filter processing units 31 and 32. The filter processing units 31 and 32 perform filter processing on the input image data using filter functions that are formed of filter coefficients that are read out from the filter coefficient storing register 20. The filter processing units 31 and 32 output the processed data as output image data.

The filter processing units 31 and 32 read out different filter coefficients. In the second exemplary embodiment, the filter processing unit 31 reads out filter coefficients ka to ke, and the filter processing unit 32 reads out filter coefficients ka, and kf to ki. In short, the filter processing units 31 and 32 are provided in accordance with luminance change directions of the input image data. Note that only one processing unit may be provided as the filter processing units 31 and 32 as long as it can perform image processing based on different filter functions.

By supplying the filter functions generated by the filter coefficient calculation unit 10 to the image processing device, the circuit size of the image processing circuit 30 can be reduced while improving the accuracy of the filter processing.

Typically, the circuit size of the image processing circuit 30 is greatly influenced by the calculation accuracy with which the calculation is performed. For example, the circuit size increases when the bit number (digit number) of the filter coefficients is made larger in order to express the filter coefficients with high accuracy. Further, if the bit number that expresses the filter coefficients is made smaller in order to suppress the circuit size, the rounding error occurs in the filter coefficients, which increases the error of the filter functions and decreases the calculation accuracy. However, these problems can be solved with the filter coefficient calculation unit 10.

The filter coefficient calculation unit 10 is able to generate the filter functions by correcting the error including the rounding error that occurs when suppressing the bit number of the filter coefficients. Hence, by inputting the filter functions generated by the filter coefficient calculation unit 10 into the image processing circuit 30, the number of calculation bits of the image processing circuit 30 can be suppressed and the increase of the circuit size can be suppressed. Further, as the filter functions generated by the filter coefficient calculation unit 10 are able to correct the error including the rounding error, the accuracy of the image processing of the image processing circuit 30 can be improved by using the filter functions.

The first and second exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above. For example, the filter function may be other filters than the Gaussian filter and the Laplacian filter.

Further, the scope of the claims is not limited by the exemplary embodiments described above.

Furthermore, it is noted that, Applicant's intent is to encompass equivalents of all claim elements, even if amended later during prosecution.

What is claimed is:

1. A filter coefficient calculation method that calculates filter functions, each having (2n+1) rows and (2n+1) columns (n is an integer), the method comprising:
calculating a first filter function in accordance with a set value that is externally input;
calculating an error between a total sum of values included in the first filter function and an ideal value of the total sum;
supplying an odd error included in the error to a first origin coefficient that is located at a center of the first filter function as a first correction value if the error is an odd number; and
supplying an even error to one of the first origin coefficient and a coefficient pair that is located symmetrically with respect to a point of the first origin coefficient as a second correction value, the even error being the error except the odd error.

2. The filter coefficient calculation method according to claim 1, wherein a value obtained by equally dividing the second correction value is supplied to each of two first neighboring coefficients that form the coefficient pair.

3. The filter coefficient calculation method according to claim 2, wherein the second correction value is divided between a plurality of coefficient pairs according to weight of the first neighboring coefficients.

4. The filter coefficient calculation method according to claim 1, comprising:
calculating a second filter function based on the set value, the second filter function being different from the first filter function;
generating a third filter function by replacing a second origin coefficient which is located at a center of the second filter function with the first origin coefficient;
calculating an error between a total sum of values included in the third filter function and an ideal value of the total sum; and
supplying the error to a coefficient pair which is located symmetrically with respect to a point of the first origin coefficient as a third correction value.

5. The filter coefficient calculation method according to claim 4, wherein a value obtained by equally dividing the third correction value is supplied to each of two second neighboring coefficients that form the coefficient pair.

6. The filter coefficient calculation method according to claim 5, wherein the third correction value is divided between a plurality of coefficient pairs according to weight of the second neighboring coefficients.

7. The filter coefficient calculation method according to claim 1, wherein the first, correction value is supplied by manipulating a least significant bit of the first origin coefficient when the least significant bit of the error is 1 when each of the first filter function and the error is represented by a value of a binary number.

8. The filter coefficient calculation method according to claim 1, wherein the filter function is a Gaussian filter.

9. The filter coefficient calculation method according to claim 1, wherein the filter function is a Laplacian filter.

10. A filter coefficient calculation unit comprising:
a weight coefficient calculation unit that calculates a first filter function having (2n+1) rows and (2n+1) columns (n is an integer) according to a set value that is externally input;
an error calculation unit that calculates an error between a total sum of values included in the first filter function and an ideal value of the total sum;
an odd error correction unit that supplies an odd error included in the error to a first origin coefficient that is located at a center of the first filter function as a first correction value if the error is an odd number, so as to correct the first origin coefficient; and
an even error correction unit that supplies an even error to one of the first origin coefficient and a coefficient pair that is located symmetrically with respect to a point of the first origin coefficient as a second correction value, the even error being the error except the odd error, so as to correct the error of the first filter function.

11. The filter coefficient calculation unit according to claim 10, wherein the even error correction unit supplies a value obtained by equally dividing the second correction value to each of two first neighboring coefficients that form the coefficient pair.

12. The filter coefficient calculation unit according to claim 11, wherein the even error correction unit divides the second correction value between a plurality of coefficient pairs according to weight of the first neighboring coefficients.

13. The filter coefficient calculation unit according to claim 10, wherein:
the weight coefficient calculation unit calculates a second filter function based on the set value, the second filter function being different from the first filter function;
the error calculation unit calculates an error between a total sum of values included in a third filter function and an ideal value of the total sum, the third filter function being obtained by replacing a second origin coefficient located at a center of the second filter function with the first origin coefficient; and
the even error correction unit supplies the error to a coefficient pair which is located symmetrically with respect to a point of the first origin coefficient as a third correction value.

14. The filter coefficient calculation unit according to claim 13, wherein the even error correction unit supplies a value obtained by equally dividing the third correction value to each of two second neighboring coefficients that form the coefficient pair.

15. The filter coefficient calculation unit according to claim 14, wherein the even error correction unit divides the third correction value between a plurality of coefficient pairs according to weight of the second neighboring coefficients.

16. The filter coefficient calculation unit according to claim 10, wherein the odd error correction unit supplies the first correction value by manipulating a least significant bit of the first origin coefficient when the least significant bit of the error is 1 when each of the first filter function and the error is represented by a value of a binary number.

17. The filter coefficient calculation unit according to claim 10, wherein the even error correction unit stores the first filter function after correcting the coefficients in the filter coefficient storing register.

18. The filter coefficient calculation unit according to claim 10, wherein
the error calculation unit reads out the first origin coefficient of the first filter function stored in the filter coefficient storing register to replace the second origin coefficient of the second filter coefficient with the first origin coefficient; and
the even error correction unit stores neighboring coefficients of the second filter function after correcting the coefficients except the first origin coefficient in the filter coefficient storing register.

19. The filter coefficient calculation unit according to claim 10, wherein the filter function is a Gaussian filter.

20. The filter coefficient calculation unit according to claim 10, wherein the filter function is a Laplacian filter.
